(19) United States
(12) Patent Application Publication
(10) Pub. No.: US 2012/0223939 A1
(43) Pub. Date: Sep. 6, 2012

(54) RENDERING STRATEGY FOR MONOSCOPIC, STEREOSCOPIC AND MULTI-VIEW COMPUTER GENERATED IMAGERY, SYSTEM USING THE SAME AND RECORDING MEDIUM FOR THE SAME

(76) Inventors: Junyong Noh, Daejeon (KR); Roger Blanco Ribera, Daejeon (KR)

(21) Appl. No.: 13/095,464

(22) Filed: Apr. 27, 2011

(30) Foreign Application Priority Data
Mar. 2, 2011 (KR) 10-2011-0018562

(51) Int. Cl. G06T 11/00; G06T 15/00

(52) U.S. Cl. 345/419; 345/418

(57) ABSTRACT

Provided are a rendering method for monoscopic, stereoscopic, and multi-view computer generated imagery, a rendering system, and a recording medium thereof. When rendering an image sequence having a plurality of consecutive frames, standard frames are initially selected and rendered, and then normal frames between the selected standard frames are rendered by receiving rendering information of a preceding frame in time in a channel and rendering information of a subsequent frame as transfer functions, thereby reducing rendering time and rendering error. If the image sequence is a multi-channel image sequence for stereoscopic and multi-view imagery, rendering information of a simultaneous frame in a neighboring channel can be additionally received as a transfer function, thus allowing more efficient rendering.

### CROSS-REFERENCE TO RELATED APPLICATIONS

This application claims priority under 35 U.S.C. §119 to Korean Patent Application No. 10-2011-0018562, filed on Mar. 2, 2011, in the Korean Intellectual Property Office, the disclosure of which is incorporated herein by reference in its entirety.

### BACKGROUND OF THE INVENTION

1. Technical Field of the Invention

The following disclosure relates to a rendering method, a system using the same, and a recording medium for the same, and in particular, to a rendering method for monoscopic, stereoscopic and multi-view computer generated imagery, a system using the same, and a recording medium for the same.

2. Background Information

Rendering is an unavoidable part of the creation of computer generated visual content in most cases. The animated or computer graphics (CG) created content is composed by a set of images, referred to as so-called frames.

The advances in computer graphics technology have reduced the rendering times but the main focus of the computer graphics technology has been to create compelling images. The state-of-the-art techniques such as ray tracing or 3D textures achieve incredibly realistic results in comparison to existing image generating methods but involve very complicated operations. Also, the state-of-the-art techniques involve an additional considerable rendering time per each frame. In some cases, rendering times can raise up to 90 hours per frame or even more. In addition, the standard frame rates for a feature film are 24, or 30 frames per second. For instance, a 1-hour-and-30-minutes film at 24 frames per second sums up to a total 129,600 frames to be rendered. Additionally, image resolutions increase along with the development of imagery, increasing the number of pixels to be rendered exponentially with the size of the image. Thus, the time taken for rendering when creating image contents will further increase.

The render farm and parallel rendering technique is utilized as one of the methodologies to reduce the rendering time. However, since the render farm and parallel rendering technique saves the rendering time as a plurality of processing cores independently performs parallel rendering, although the render farm and parallel rendering technique reduces the rendering time by enhancing hardware performance, it results in the increase of installation costs. Thus, this technique demands a lot of costs, which makes it inapplicable to wide-ranging applications.

For the above reason, even though it is not a part of the core creative process, the rendering process is one of the most time-consuming tasks during the creation of computer generated sequences for visual effects or animation films, which causes the increase of costs required for producing image contents. In particular, rendering of 3-dimensional stereoscopic images consumes much more time than rendering of 2-dimensional images. Even more, since recent advancement of 3-dimensional stereoscopic images allows multi-view imagery, the time required for rendering is increasing rapidly.

### SUMMARY OF THE INVENTION

The present disclosure is directed to providing a rendering method for monoscopic computer generated imagery.

The present disclosure is also directed to providing a rendering method for stereoscopic and multi-view computer generated imagery.

The present disclosure is further directed to providing a rendering system using the above methods.

In one aspect of the present disclosure, there is provided a rendering method for monoscopic computer generated imagery, which includes applying an image sequence having a plurality of frames consecutively obtained in time; rendering a plurality of standard frames discrete in time among the plurality of frames; and rendering at least one normal frame between the rendered plurality of standard frames by using a transfer function sequentially transmitted from the rendered plurality of standard frames through neighboring frames that are preceding or succeeding in time.

In another aspect of the present disclosure, there is also provided a rendering method for stereoscopic and multi-view computer generated imagery, which includes applying an image sequence having a plurality of channels, each channel having a plurality of frames consecutively obtained in time; rendering a plurality of standard frames discrete in time among the plurality of frames in each of the plurality of channels; rendering at least one normal frame between the plurality of standard frames in each of the plurality of channels by using a transfer function sequentially transmitted from the rendered plurality of standard frames through neighboring frames that are preceding or succeeding in time; and additionally rendering normal frames in a neighboring channel among the plurality of channels by using the transfer functions transmitted from at least one of the rendered plurality of standard frames or the at least one rendered normal frame.

The rendering of the plurality of standard frames can include sequentially checking rates of change of the plurality of frames in each of the plurality of channels of the image sequence; selecting frames from the plurality of frames having a rate of change greater than a first standard value as the plurality of standard frames; and rendering the selected plurality of standard frames.

The selecting of the plurality of standard frames can include checking a rate of change of a succeeding frame if the rate of change of a frame of the plurality of frames is smaller than the first standard value; checking a rate of change between the selected plurality of standard frames; and adding a standard frame between the selected plurality of standard frames if the rate of change between the selected plurality of standard frames is greater than a second standard value.

The checking of the rate of change of the succeeding frame can include determining whether the number of checked frames is greater than a set number of frames; checking the rate of change of the succeeding frame if the number of checked frames is not greater than the set number of frames; and setting the current frame as a standard frame if the umber of checked frames is greater than the set number of frames.

The rendering of the at least one normal frame using the transfer function can include transmitting rendering information of the rendered plurality of standard frames as the transfer function to preceding and succeeding normal frames neighboring the rendered plurality of standard frames in time; rendering the normal frames neighboring the rendered plurality of standard frames by using the transfer function; and transmitting rendering information of the rendered normal frames as the transfer function to other preceding and succeeding normal frames neighboring the rendered normal frames in time and rendering said other normal frames.

The rendering of the at least one normal frame using the transfer function can further include rendering the neighboring normal frames sequentially in a time order from the rendered standard frames, and then rendering the neighboring normal frames sequentially in a reverse time order.

The additional rendering can include transmitting rendering information of simultaneous frames in neighboring channels among the plurality of channels as the transfer function; and rendering the normal frames by using the transfer function of the simultaneous frames in the neighboring channels.

The additional rendering can further include rendering the neighboring normal frames from a channel in one side to a channel in another side among the plurality of channels, and then rendering the neighboring normal frames from the channel in another side to the channel in the one side.

The applying an image sequence can include applying the image sequence from the outside, and buffering the image sequence.

Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a schematic diagram showing a rendering system according to an embodiment of the present disclosure;

FIG. 2 is a schematic diagram showing a rendering process for monoscopic computer generated imagery according to an embodiment of the present disclosure;

FIG. 3 is a flowchart illustrating a rendering method according to an embodiment of the present disclosure;

FIG. 4 is a schematic diagram illustrating a rendering method for stereoscopic computer generated imagery according to another embodiment of the present disclosure; and

FIG. 5 is a schematic diagram illustrating a rendering method for multi-view computer generated imagery according to another embodiment of the present disclosure.

### DETAILED DESCRIPTION OF EMBODIMENTS

The advantages, features and aspects of the present disclosure will become apparent from the following description of the embodiments with reference to the accompanying drawings, which is set forth hereinafter. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

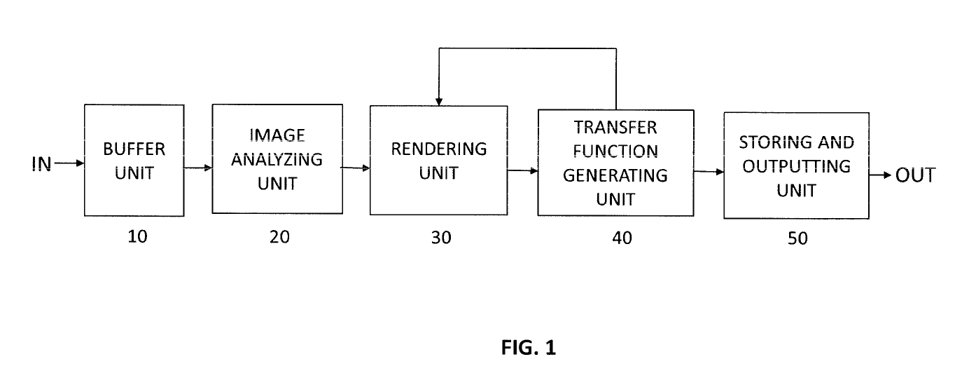

FIG. 1 is a schematic diagram showing a rendering system according to an embodiment of the present disclosure.

Referring to FIG. 1, the rendering system of the present disclosure includes a buffer unit 10, an image analyzing unit 20, a rendering unit 30, a transfer function generating unit 40, and a storing and outputting unit 50.

The buffer unit 10 buffers an input image sequence (in) applied from the outside and stores the input image sequence. Generally, the image sequence used as visual contents is composed of a plurality of frames, and the plurality of consecutive frames mostly have similar inner images, except for a special case such as a shift of scene. Thus, a system that receives and processes the image sequence (in) is mostly provided with a buffer to image-process a plurality of frames at the same time, or a succeeding frame is image-processed based on the previously image-processed frame. Also, the rendering system of the present disclosure includes the buffer unit 10 to buffer an image sequence (in) so that a plurality of consecutive frames in the applied image sequence (in) can be image-processed.

The image analyzing unit 20 receives the image sequence (in) buffered by the buffering unit 10 and analyzes images frame by frame. For example, the image analyzing unit 20 determines whether there is found a frame with a significantly different inner image from a preceding frame, as in the case of a shift of scene, and then, if there is found a frame with a significantly different inner image from a preceding frame, the image analyzing unit 20 selects the corresponding frame and the preceding frame as standard frames, respectively. Here, various image analyzing techniques well known in the art can be used for determining whether a current frame has a significantly different inner image from a preceding frame. In the image analyzing unit 20, standard values used for determining whether or not to select the preceding frame and the current frame as standard frames can be set in advance. Also, in the present disclosure, a plurality of standard values can be set in the image analyzing unit 20 so that standard frames can be selected even in consecutive frames that do not have significantly different inner images, for the purpose of ensuring easier rendering of the image sequence.

The rendering unit 30 renders the standard frames selected by the image analyzing unit 20. When the rendering unit 30 renders the standard frames, the rendering unit 30 renders the entire inner image of the standard frames.

Also, the rendering unit 30 renders other frames (hereinafter “normal frames”) than the standard frames, by using a transfer function applied from the transfer function generating unit 40. However, when rendering a normal frame, the rendering unit 30 performs rendering by using a transfer function applied from a neighboring frame. If a transfer function is used for rendering, rendering information is utilized through a transfer function of a neighboring frame, rather than rendering the entire inner image of each frame, and thus the rendering work can be performed in a very simple way as compared to the rendering work for the standard frames, wherein the entire inner image is rendered.

In the rendering system of the present disclosure, when rendering the normal frames, the rendering unit 30 performs rendering while receiving rendering information of a succeeding frame as well as a preceding frame in time among consecutive frames. As described above, the image sequence (in) to be rendered is composed of a plurality of consecutive frames, and the plurality of consecutive frames are buffered by and stored in the buffer unit 10. Also, the rendering unit 30 firstly renders the standard frames among the plurality of frames stored in the buffer unit 10. Thus, rendering information for a preceding frame and a succeeding frame can be applied as a transfer function for at least one frame arranged between two standard frames since a preceding standard frame and a succeeding standard frame thereof are already rendered in advance.

In a case where the image sequence is not a single channel image sequence for monoscopic computer generated imagery but a two-channel image sequence for stereoscopic computer generated imagery or a multi-channel image sequence for multi-view computer generated imagery, the rendering unit 30 can be used for rendering while receiving rendering information of a simultaneous frame in a neighboring channel as well as the rendering information of a preceding frame and a succeeding frame.

The transfer function generating unit 40 receives the standard frames and the normal frames, which are rendered by the rendering unit 30, and the rendering information of the standard frames and the normal frames to generate a transfer function and feed the transfer function back to the rendering unit 30, and transmits the rendered standard frames and the rendered normal frames to the storing and outputting unit 50. The transfer function generating unit 40 generates a transfer function for a preceding frame and a transfer function for a succeeding frame from the rendering information of the rendered standard frames and the rendered normal frames, and transmits the transfer functions to the rendering unit 30. If the image sequence is a multi-channel image sequence for stereoscopic or multi-view imagery as described above, the transfer function generating unit 40 additionally generates a transfer function for a simultaneous frame in a neighboring frame and transmits the transfer function to the rendering unit 30.

Here, the transfer function can be generated in various ways, and many techniques for generating transfer functions are already known in the art. Representatively, a motion vector (or, a vector map) used in the optical flow technique can be used as a transfer function. The motion vector traces the motion of an object across time, and it can be used for both single-channel image sequences and multi-channel image sequences. In a case where the image sequence is a multi-channel image sequence, a depth map or a disparity map can be used as a transfer function, for example. The multi-channel image sequence is used for 3-dimensional stereoscopic images in most cases, and the depth map and the disparity map are generally used in 3-dimensional stereoscopic images. The depth map is obtained by encoding distance information of each object from a camera in a specific scene, and each pixel value of the depth map to be rendered is proportional to the distance from the camera to a compartmental object. Also, the disparity map is information representing disparity between channels in a multi-channel image sequence. Also, the depth map and the disparity map have close correlation, generally inversely proportional to each other.

The storing and outputting unit 50 stores a plurality of frames in a rendered image sequence, arranges the frames in a time order, and outputs the frames to the outside. As described above, the rendering system of the present disclosure does not render frames in a time order, but renders the selected standard frames and then renders normal frames from a frame neighboring the rendered standard frame to gradually further frames by using the transfer frame. Thus, since the plurality of frames in the image sequence are not rendered in a time order, the plurality of rendered frames should be rearranged in a time order so as to output a rendered image sequence. Thus, the storing and outputting unit 50 stores the plurality of rendered and received frames firstly in order to rearrange the plurality of frames, and after the rearrangement, the storing and outputting unit 50 outputs the rendered and rearranged image sequence (out) to the outside.

In other words, the rendering method of the present disclosure analyzes a plurality of frames in an image sequence applied thereto to select and render standard frames that are discrete in time, generates a transfer function by using the rendering information of the rendered standard frames to render normal frames neighboring the rendered standard frames, and then generates a transfer function by using the rendering information of the rendered normal frames to successively render neighboring normal frames.

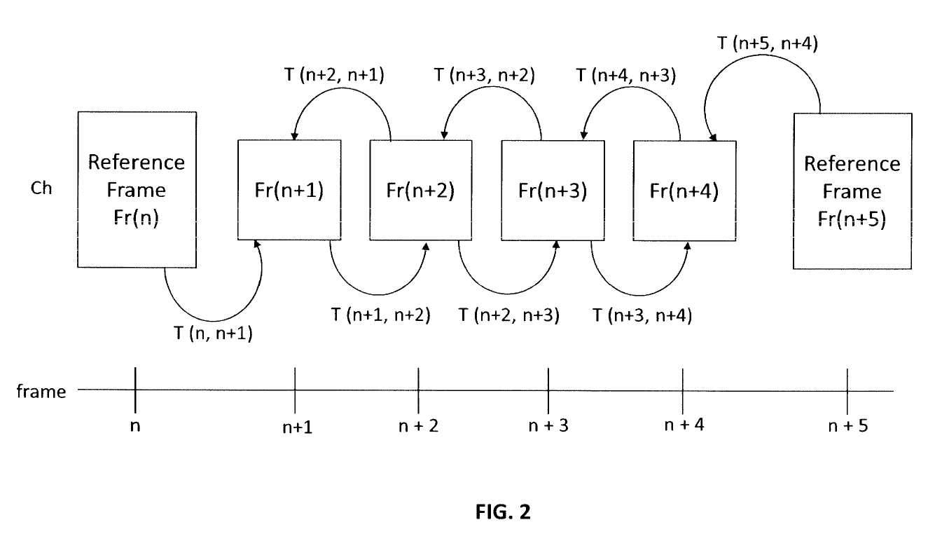

FIG. 2 is a schematic diagram showing a rendering process for monoscopic computer generated imagery according to an embodiment of the present disclosure.

FIG. 2 illustrates rendering for monoscopic imagery, which represents a single-channel image sequence, and among a plurality of consecutive frames in the image sequence, only five frames consecutive from an n^{th} frame Fr(n) are depicted. Also, in FIG. 2, it is assumed that the n^{th} frame Fr(n) and the n+5^{th} frame Fr(n+5) are selected as standard frames by the image analyzing unit 20.

Since the n^{th} frame Fr(n) and the n+5^{th} frame Fr(n+5) are selected as standard frames, an n+1^{th} frame Fr(n+1) to an n+4^{th} frame Fr(n+4) between the n^{th} frame Fr(n) and the n+5^{th} frame Fr(n+5) are normal frames. The rendering system according to the present disclosure as described above firstly renders the standard frames Fr(n) and Fr(n+5) selected by the rendering unit 30.

Then, the transfer function generating unit 40 generates transfer functions T(n,n+1) and T(n+5,n+4) for rendering respective neighboring frames based on the rendering information of the rendered standard frames Fr(n) and Fr(n+5), and feeds the generated transfer functions T(n,n+1) and T(n+5,n+4) back to the rendering unit 30.

The rendering unit 30 renders normal frames Fr(n+1) and Fr(n+4) neighboring the standard frames Fr(n) and Fr(n+5) by using the transfer functions T(n,n+1) and T(n+5,n+4) fed back thereto and applied from the transfer function generating unit 40, and the transfer function generating unit 40 generates transfer functions T(n+1,n+2) and T(n+4,n+3) for rendering respective neighboring frames based on the rendering information of the rendered normal frames Fr(n+1) and Fr(n+4) again, and feeds the generated transfer functions T(n+1,n+2) and T(n+4,n+3) back to the rendering unit 30. In other words, the rendering unit 30 and the transfer function generating unit 40 repeat the processes of sequentially rendering neighboring normal frames Fr(n+1) to Fr(n+4) from the standard frames Fr(n) and Fr(n+5) and generating transfer functions. Also, if the frames to be rendered in the rendering order, after the normal frames Fr(n+4) and Fr(n+1) are rendered, are the standard frames Fr(n) and Fr(n+5), the generation of transfer functions is stopped. It is because the standard frames Fr(n) and Fr(n+5) are not rendered using transfer functions.

As shown in FIG. 2, the rendering method for monoscopic imagery according to one embodiment of the present disclosure does not render the plurality of frames in the image sequence frame by frame, but the rendering method selects and renders a predetermined number of frames and then renders the other frames, not yet rendered, based on the rendered frames by using a plurality of inter-frame transfer functions. At this time, the frames selected for rendering are discretely, not consecutively, dispersed frames in time.

As shown in FIG. 2, if the image sequence is rendered using a bi-directional transfer function, the rendering error can be decreased even when an interval between the standard frames is set wider, in comparison to the cases in which rendering is performed using a transfer function only in one direction. For example, assuming that standard frames should be selected at every five frames among a plurality of consecutive frames in an image sequence when a one-directional transfer function is used for rendering, the same frames can be rendered with similar or smaller errors by using a bi-directional transfer function even though standard frames are selected at every ten frames. It is because normal frames receive rendering information in both directions by the transfer function, and thus more rendering information can be obtained rather than the case using a one-directional transfer function. Further, considering the movement of the camera according to the flow of time, the rendering information that cannot be obtained (or, unavailable rendering information) when using only a one-directional transfer function as the rendering information can be greatly decreased if the bi-directional transfer function is used. For example, in a case where the camera moves from the left to the right, a background region hidden by a specific object can appear in succeeding frames in time with respect to the frame to be rendered. Of course, the rendering information of all background regions cannot be obtained even though rendering information of a succeeding frame is used, but the amount of unavailable rendering information can be greatly decreased in comparison to the case where only the rendering information of a preceding frame is used.

Notwithstanding, since the interval between the standard frames and the rendering error are increased in proportion to each other, the interval between the standard frames should be adjusted by a user in consideration of characteristics of the used transfer function, characteristics of the applied image sequence, quality of the output image sequence (out), or the like.

The rendering error can be measured in various ways. For example, the rendering error can be measured as an amount of regions not rendered in a rendered frame. Generally, regions unfilled in the rendering are called holes, and such holes should be reduced to the minimum in order to generate high-quality images. The process of reducing such holes is called hole filling.

As described above, since the entire inner images of the standard frames should be individually rendered without using a transfer function, a lot of time is consumed for rendering. Thus, if the number of standard frames selected for the same image sequence is decreased and the number of normal frames rendered using transfer functions is increased, the rendering time for the entire image sequence can be greatly reduced.

Thus, it is possible to reduce the rendering time and more accurately perform rendering works.

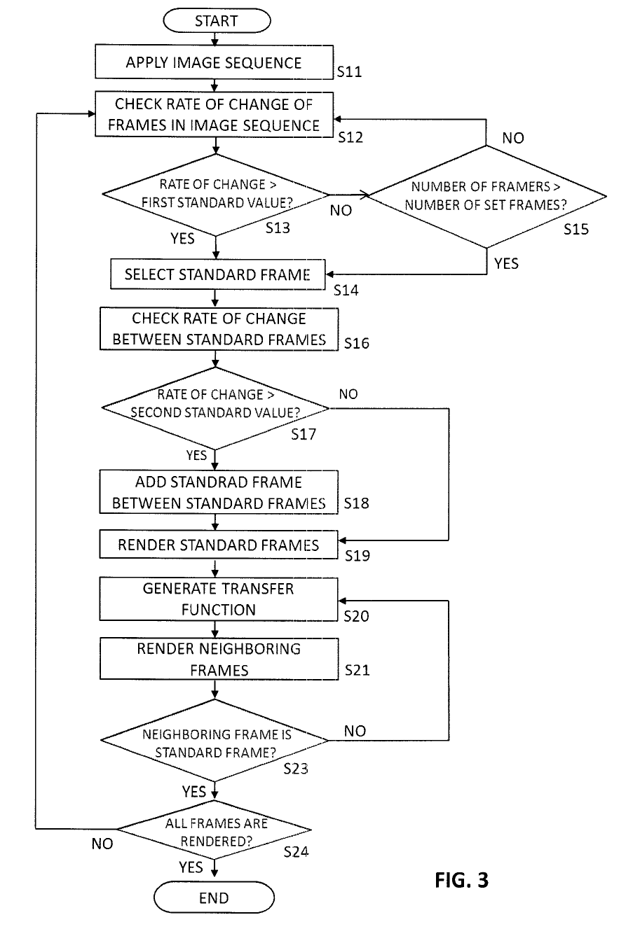

FIG. 3 illustrates a rendering method according to one embodiment of the present disclosure.

To describe the rendering method of FIG. 3 with reference to FIGS. 1 and 2, an image sequence (in) having a plurality of frames is applied to the buffer unit 10 (S11). The image sequence (in) can be a single-channel image sequence or a multi-channel image sequence. If the image sequence (in) is buffered by the buffer unit 10, the image analyzing unit 20 analyzes the image sequence (in) to check rates of change of the plurality of consecutive frames in the image sequence (in) (S12). It is determined whether the rate of change of a frame is greater than a first standard value (S13). This step is performed to select standard frames by obtaining images with significantly different inner images such as a shift of scene in the plurality of consecutive frames in the image sequence (in).

In order to perform rendering using a transfer function in the image sequence (in), several preceding conditions are demanded. The first condition is that, although a plurality of frames have different images due to the movement of an object, the movement of a camera, or the like, in an image sequence, inner images of two consecutive frames are very similar to each other. It is because a transfer function can be transferred only when two neighboring frames have similar images. Also, the second condition is that a plurality of frames are similar as a whole within a given time. The second condition is an extension of the first condition, and it means that all frames rendered using transfer functions between two standard frames should have similar inner images. The third condition is that an error region is reduced in a case where a bi-directional transfer function is used, as compared to the case where a one-directional transfer function is used. In other words, if an error region of a rendered frame is not reduced through a bi-directional transfer function, the time interval between the standard frames cannot be set broader, which decreases the effect of using the bi-directional transfer function. The violation of the third condition is an extremely rare case, for example, when a camera returns to an original position while the camera moves in one direction. However, since the time between the standard frames is generally set to be not so long to reflect such a big movement of a camera, it is a rare case to find an image sequence that violates the third condition.

In order to set standard frames satisfying the first condition among the above three conditions, in the present disclosure, it is determined whether the rate of change of a frame is greater than the preset first standard value (S13).

If the rate of change of a frame is greater than the preset first standard value, the corresponding frame is selected as a standard frame (S14). However, if the rate of change of the frame is not greater than the first standard value, it is determined whether the number of checked frames is greater than a set number of frames (S15).

It allows the time interval between two standard frames not to be increased too much. If the time interval between two standard frames is increased too much, very large storage capacities are needed for the buffer unit 10 and the storing and outputting unit 50. Also, it is not easy to cope with the case demanding instant image output such as real-time image processing. Moreover, if the time interval between the standard frames is increased, the error region can be inevitably increased even when a bi-directional transfer function is used. Thus, even if the rate of change of consecutive frames is not great, it is needed to limit the number of frames in advance, so that the interval between standard frames is not increased too much. In other words, in order to set standard frames satisfying the third condition among the above three conditions, in the present disclosure, it is determined whether the number of checked frames is greater than the set number of frames (S15).

If the number of checked frames is not greater than the set number of frames, a rate of change of a succeeding frame in the image sequence (in) is checked (S12). However, if the number of checked frames is greater than the set number of frames, the corresponding frame is selected as a standard frame as in the case where the rate of change of a frame is great (S14).

If standard frames are selected, the rate of change between the standard frames is checked (S16). The rate of change between the standard frames is checked to set standard frames satisfying the second condition among the above three conditions. It is because an error region can be increased if the rate of change between two standard frames is great, even when the rate of change between consecutive frames is not great.

If the rate of change between the standard frames is greater than a preset second standard value, it means that the rate of change in the region of the corresponding time is great, and thus one of normal frames between the selected two standard frames is selected as a standard frame (S18). Also, the rendering unit 30 renders the selected standard frames (S19). However, if the rate of change between the standard frames is not greater than the preset second standard value, the selected standard frames are rendered without adding a further standard frame (S19).

If the rendering of the selected standard frames is completed, the transfer function generating unit 40 generates a transfer function based on the rendering information of the rendered standard frames and feeds the transfer function back to the rendering unit 30 (S20). Then, by using the transfer function fed back to the rendering unit 30, the rendering unit 30 renders neighboring frames before and after the standard frames in time (S21).

After the frames are rendered, the transfer function generating unit 40 checks whether a neighboring frame in the other side in the previous rendering order of the rendered frames is a standard frame (S23). If the neighboring frame in the other side is not a standard frame, a transfer function is generated again to render the neighboring frame in the other side and is fed back to the rendering unit 30. However, if the neighboring frame in the other side is a standard frame, the standard frame does not need to be rendered since the standard frame is already rendered. Thus, it is determined that the currently selected standard frames and the normal frames between the standard frames are all rendered, and it is determined whether there is any frame not yet rendered in the image sequence (S24). If all frames are rendered, the rendering work is completed, but, if there is a frame not yet rendered, the rate of change of the frame in the image sequence is checked to select a standard frame again (S12).

In the above embodiment, the first and second standard values and the set number of frames can be adjusted in accordance with the used rendering time transfer function.

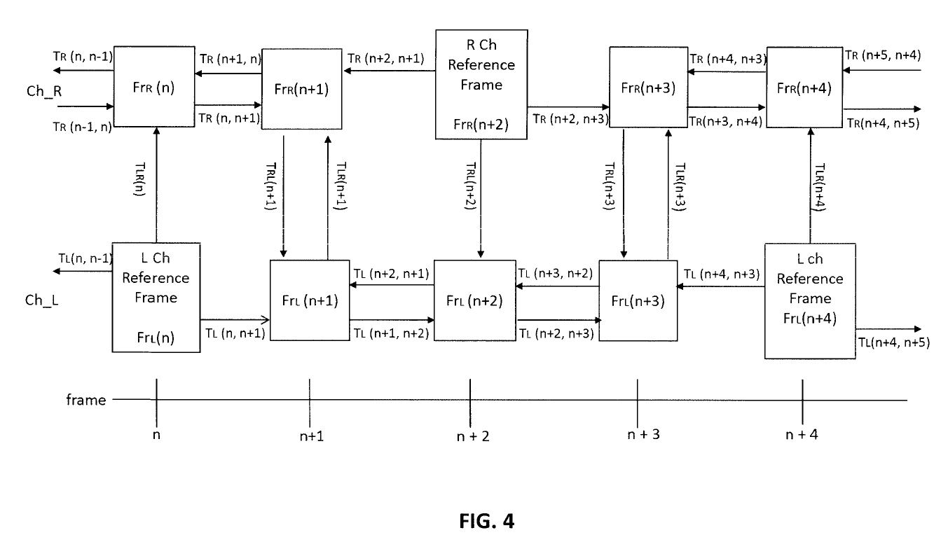

FIG. 4 is a diagram illustrating a rendering method for stereoscopic imagery according to another embodiment of the present disclosure.

The image sequence for stereoscopic imagery is a basic image sequence for generating 3D stereoscopic images and is generally generated with two channels, i.e., a left channel Ch_L and a right channel Ch_R, by using two left and right cameras. Since the two right and left cameras are disposed at a rig for stereoscopic imaging, rendering information, namely a transfer function, can be transmitted from one camera to the other camera if locations of both cameras and a distance between the cameras at the rig are known.

In the present disclosure, as shown in FIG. 4, a transfer function is transmitted bi-directionally in time for each channel in an image sequence for stereoscopic imagery, and also a transfer function is transmitted mutually between two channels Ch_L and Ch_R. In the image sequence for stereoscopic imagery, simultaneous frames of channels are obtained due to the difference in viewpoint substantially caused by different locations of the cameras, and thus simultaneous frames of the channels have similar inner images, identically to neighboring frames in the same channel. Thus, similarly to the case where a transfer function is used bi-directionally in an image sequence for monoscopic imagery, transfer functions can be mutually used between two channels Ch_L and Ch_R to render a plurality of frames.

FIG. 4 shows a rendering process in two channels Ch_L and Ch_R, respectively from n^{th} frames Fr_{L}(n) and Fr_{R}(n) to n+4^{th frames Fr}_{L}(n+4) and Fr_{R}(n+4). It is assumed that the n^{th} frame Fr_{L}(n) and the n+4^{th} frame Fr_{L}(n+4) are selected as standard frames in the left channel Ch_L, and the n+2^{th} frame Fr_{R}(n+2) is selected as a standard frame in the right channel (Ch_R). In the two channels Ch_L and Ch_R, simultaneous frames in two channels Ch_L and Ch_R can be selected as standard frames, but a rendering error can be reduced by selecting frames of different times as standard frames in two channels Ch_L and Ch_R in a case where a transfer function is transmitted for rendering.

In addition, as shown in FIG. 4, the process of transmitting a transfer function for rendering each frame in the same channel is identical to the process of transmitting a transfer function for rendering frames in a single channel as shown in FIG. 2. However, differently from FIG. 2, in FIG. 4, if frames to be rendered are not standard frames Fr_{L}(n+4), Fr_{R}(n+4), Fr_{R}(n+2) but normal frames, the corresponding frames are rendered by receiving transfer functions not only from neighboring frames in time in the same channel, but also from a simultaneous frame in another channel. One normal frame receives three transfer functions in total from two bi-directionally neighboring frames in the same channel and one frame in a neighboring channel. Thus, the rendering error can be further decreased as compared to the case where transfer functions are received bi-directionally in the same channel for rendering.

For example, in a case where an n+1^{th} frame Fr_{L}(n+1) is rendered in FIG. 4, the rendering unit 30 receives not only transfer functions T_{L}(n,n+1) and T_{L}(n+2,n+1) including rendering information of an n^{th} frame Fr_{L}(n) and an n+2^{th} frame Fr_{L}(n+2) in the left channel Ch_L, but also a transfer function T_{RL}(n+1) including rendering information of an n+1^{th} frame Fr_{R}(n+1) in the right channel Ch_R.

In addition, the rendering information of the n+1^{th} frame Fr_{L}(n+1) is applied as a transfer function T_{L}(n+1,n+2) for rendering the n+2^{th} frame Fr_{L}(n+2) in the same channel Ch_L, and also is applied as a transfer function T_{LR}(n+1) for rendering the n+1^{th} frame Fr_{R}(n+1) in the right channel Ch_R. However, the n^{th} frame Fr_{L}(n) in the same channel Ch_L does not receive a transfer function since it is a standard frame.

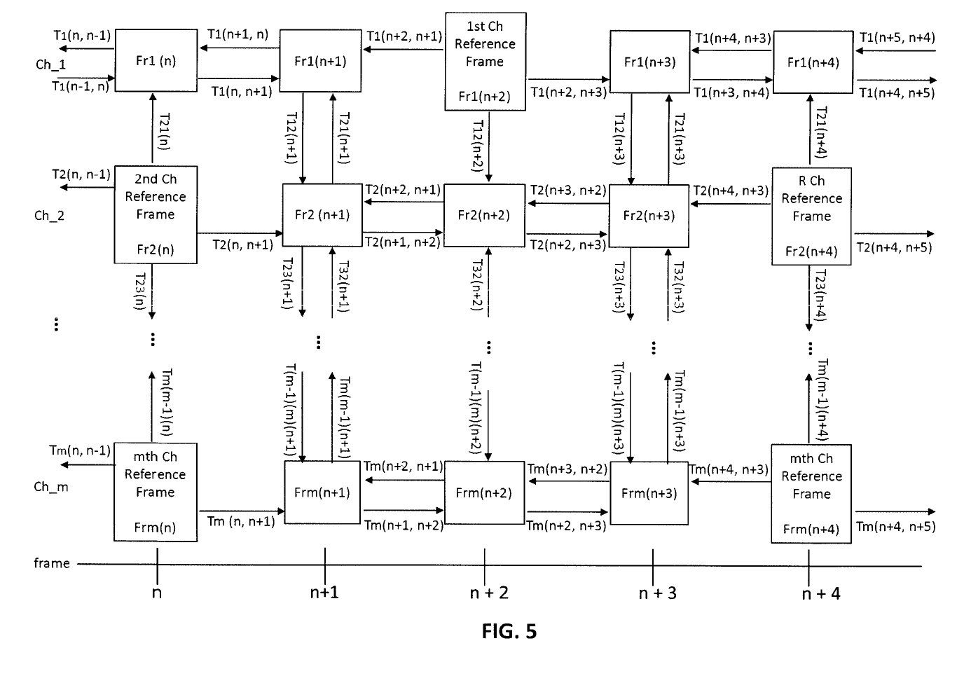

FIG. 5 is a diagram illustrating a rendering method for multi-view imagery according to another embodiment of the present disclosure.

The image sequence for multi-view imagery is an extended concept of the stereoscopic imagery and employs a plurality of consecutive frames in each of m channels Ch_1 to Ch_m applied from m cameras (m is a natural number greater than 2) in order to provide multiple viewpoints. The stereoscopic imagery employs two channels, and thus the rendering work is performed such that two channels Ch_L and Ch_R mutually transmit transfer functions. However, since the multi-view imagery employs more channels than the stereoscopic imagery, a frame in one channel can receive transfer functions from neighboring channels at both sides by extending the rendering method for stereoscopic imagery. For example, the n+3^{th} frame Fr₂(n+3) in a second channel Ch_2 can perform rendering by receiving transfer functions T₂(n+2,n+3) and T₂(n+4,n+3) including the rendering information of neighboring frames Fr₂(n+2) and Fr₂(n+4) at both sides in time in the same channel Ch_2, and transfer functions T₁₂(n+3) and T₃₂(n+3) including the rendering information of simultaneous frames Fr₁(n+3) and Fr₃(n+3) in neighboring channels Ch_1 and Ch_3 at both sides. In other words, as shown in FIG. 5, transfer functions T₂(n+2,n+3), T₂(n+4,n+3), T₁₂(n+3), and T₃₂(n+3) are received in four directions.

However, since channels Ch_1 and Ch_m at both ends respectively have a neighboring channel Ch_2 and Ch_m−1 only in one side, the channels Ch_1 and Ch_m receive transfer functions in three directions similarly to the rendering of an image sequence for stereoscopic imagery.

The neighboring channel in the multi-view imagery means an image sequence applied from a neighboring camera among n number of cameras. Thus, the neighboring channels have similar inner images, allowing the rendering information to be used for reducing a rendering error as described above.

Although it has been described that the rendering work from standard frames to normal frames is performed without any order in each direction, it is possible to set the order of priority and perform the rendering work in accordance with the order of priority for stable rendering. Seeing the multi-channel image sequence in FIG. 5 for example, after standard frames in all channels Ch_1 to Ch_m are rendered first, normal frames are rendered in each channel Ch_1 to Ch_m in a time order. Also, the normal frames are rendered again in a reverse time order. After that, the normal frames are rendered in the order from the first channel Ch_1 to the m^{th} channel Ch_m, and finally the normal frames are rendered from the M^{th} channel Ch_m to the first channel Ch_1, thereby completing the rendering work.

Thus, a rendering method for monoscopic, stereoscopic, and multi-view computer generated imagery, a rendering system, and a recording medium thereof according to the present disclosure receive rendering information of a preceding frame in time in a channel and rendering information of a succeeding frame as transfer functions, and then render frames, thereby reducing rendering time and rendering error. Further, in a case where the image sequence is a multi-channel image sequence for stereoscopic and multi-view imagery, rendering information of a simultaneous frame in a neighboring channel can be additionally received as a transfer function, which allows more efficient rendering.

While the present disclosure has been described with respect to the specific embodiments, it will be apparent to those skilled in the art that various changes and modifications can be made without departing from the spirit and scope of the disclosure as defined in the following claims.

1. A rendering method for monoscopic computer generated imagery, the rendering method comprising:
applying an image sequence having a plurality of frames consecutively obtained in time;
rendering a plurality of standard frames discrete in time among the plurality of frames; and
rendering at least one normal frame between the rendered plurality of standard frames by using a transfer function sequentially transmitted from the rendered plurality of standard frames through neighboring frames that are preceding or succeeding in time.

2. The rendering method for monoscopic computer generated imagery according to claim 1, wherein said rendering of the plurality of standard frames includes:
sequentially checking rates of change of the plurality of frames in the image sequence;
selecting frames from the plurality of frames having a rate of change greater than a first standard value as the plurality of standard frames; and
rendering the selected plurality of standard frames.

3. The rendering method for monoscopic computer generated imagery according to claim 2, wherein said selecting of the plurality of standard frames includes:
checking a rate of change of a succeeding frame if the rate of change of a frame of the plurality of frames is smaller than the first standard value;
checking a rate of change between the selected plurality of standard frames; and
adding a standard frame between the selected plurality of standard frames if the rate of change between the selected plurality of standard frames is greater than a second standard value.

4. The rendering method for monoscopic computer generated imagery according to claim 3, wherein said checking of the rate of change of the succeeding frame includes:
determining whether the number of checked frames is greater than a set number of frames;
checking the rate of change of the succeeding frame if the number of checked frames is not greater than the set number of frames; and
setting a current frame as the standard frame if the number of checked frames is greater than the set number of frames.

5. The rendering method for monoscopic computer generated imagery according to claim 1, wherein said rendering of the at least one normal frame using the transfer function includes:
transmitting rendering information of the rendered plurality of standard frames as the transfer function to preceding and succeeding normal frames neighboring the rendered plurality of standard frames in time;
rendering the normal frames neighboring the rendered plurality of standard frames by using the transfer function; and
transmitting rendering information of the rendered normal frames as the transfer function to other preceding and succeeding normal frames neighboring the rendered normal frames in time and rendering said other normal frames.

6. The rendering method for monoscopic computer generated imagery according to claim 5, wherein said rendering of the at least one normal frame using the transfer function further includes:
rendering the neighboring normal frames sequentially in a time order from the rendered standard frames, and then rendering the neighboring normal frames sequentially in a reverse time order.

7. A rendering method for stereoscopic and multi-view computer generated imagery, the rendering method comprising:
applying an image sequence having a plurality of channels, each channel having a plurality of frames consecutively obtained in time;
rendering a plurality of standard frames discrete in time among the plurality of frames in each of the plurality of channels;
rendering at least one normal frame between the plurality of standard frames in each of the plurality of channels by using a transfer function sequentially transmitted from the rendered plurality of standard frames through neighboring frames that are preceding or succeeding in time; and
additionally rendering normal frames in a neighboring channel among the plurality of channels by using the transfer functions transmitted from at least one of the rendered plurality of standard frames or the at least one rendered normal frame.

8. The rendering method for stereoscopic and multi-view computer generated imagery according to claim 7, wherein said rendering of the plurality of standard frames includes:
sequentially checking rates of change of the plurality of frames in each of the plurality of channels of the image sequence;
selecting frames from the plurality of frames having a rate of change greater than a first standard value as the plurality of standard frames; and
rendering the selected plurality of standard frames.

9. The rendering method for stereoscopic and multi-view computer generated imagery according to claim 8, wherein said selecting of the plurality of standard frames includes:
checking a rate of change of a succeeding frame if the rate of change of a frame of the plurality of frames is smaller than the first standard value;
checking a rate of change between the selected plurality of standard frames; and
adding a standard frame between the selected plurality of standard frames if the rate of change between the selected plurality of standard frames is greater than a second standard value.

10. The rendering method for stereoscopic and multi-view computer generate imagery according to claim 9, wherein said checking of the rate of change of the succeeding frame includes:
determining whether the number of checked frames is greater than a set number of frames;
checking the rate of change of the succeeding frame if the number of checked frames is not greater than the set number of frames; and
setting a current frame as the standard frame if the number of checked frames is greater than the set number of frames.

11. The rendering method for stereoscopic and multi-view computer generated imagery according to claim 7, wherein said rendering of the at least one normal frame using the transfer function includes:
transmitting rendering information of the rendered plurality of standard frames as the transfer function to preceding and succeeding normal frames neighboring the rendered plurality of standard frames in time;
rendering the normal frames neighboring the rendered plurality of standard frames by using the transfer function; and
transmitting rendering information of the rendered normal frames as the transfer function to other preceding and succeeding normal frames neighboring the rendered normal frames in time and rendering said other normal frames.

12. The rendering method for stereoscopic and multi-view computer generated imagery according to claim 11, wherein said rendering of the at least one normal frame using the transfer function includes:
rendering the neighboring normal frames sequentially in a time order from the rendered standard frames, and then rendering the neighboring normal frames sequentially in a reverse time order.

13. The rendering method for stereoscopic and multi-view computer generated imagery according to claim 7, wherein said additional rendering includes:
transmitting rendering information of simultaneous frames in neighboring channels among the plurality of channels as the transfer function; and
rendering the normal frames by using the transfer function of the simultaneous frames in the neighboring channels.

14. The rendering method for stereoscopic and multi-view computer generate imagery according to claim 13, wherein said additional rendering further includes:
rendering the neighboring normal frames from a channel in one side to a channel in another side among the plurality of channels, and then rendering the neighboring normal frames from the channel in the another side to the channel in the one side.

15-20. (canceled)
